(19) United States
(12) Patent Application Publication
(10) Pub. No.: US 2025/0004881 A1
(43) Pub. Date: Jan. 2, 2025

(54) MEMORY SYSTEMS AND OPERATION METHODS THEREOF, AND READABLE STORAGE MEDIA

(71) Applicant: Yangtze Memory Technologies Co., Ltd., Wuhan, Hubei (CN)

(72) Inventor: Teng Zhou, Wuhan, Hubei (CN)

(21) Appl. No.: 18/509,019

(22) Filed: Nov. 14, 2023

(30) Foreign Application Priority Data
Jun. 30, 2023 (CN) 202310804980.X

(51) Int. Cl. G06F 11/10; G06F 11/07; G06F 11/14

(52) U.S. Cl. CPC G06F 11/108; G06F 11/0757; G06F 11/141

(57) ABSTRACT

A memory system and operation method thereof are provided according to implementations of this disclosure. The memory system comprises: at least one memory device and a memory controller coupled to the at least one memory device. The memory controller is configured to: perform part or all of a read error processing flow for at least two times, in response to a failure of a first read operation when performing a read operation on a memory region in the memory device.

### REFERENCE TO RELATED APPLICATIONS

This application claims priority to and the benefit of Chinese Patent Application 202310804980.X, filed on Jun. 30, 2023, which is hereby incorporated by reference in its entirety.

### TECHNICAL FIELD

The present disclosure relates to the technical field of semiconductor, in particular to a memory system and operation method thereof and a readable storage medium.

### BACKGROUND

Memory device is a storage device used for storing information in modern information technology. As a typical nonvolatile semiconductor memory, NAND (Not-And) memory has gradually become the mainstream product in the memory market because of its high storage density, controllable production cost, suitable erasing speed and retention characteristics.

### BRIEF DESCRIPTION OF THE DRAWINGS

FIG. 1 is a schematic diagram of an example system having a memory system according to an implementation of the present disclosure;

FIG. 2A is a schematic diagram of an example memory card having a memory system according to an implementation of the present disclosure;

FIG. 2B is a schematic diagram of an example solid-state drive having a memory system according to an implementation of the present disclosure;

FIG. 3A is a schematic diagram of the distribution of memory cells of a three-dimensional NAND type memory according to an implementation of the present disclosure;

FIG. 3B is a schematic diagram of an example memory device including peripheral circuit according to an implementation of the present disclosure:

FIG. 4 is a schematic cross-sectional view of a memory array including NAND memory strings according to an implementation of the present disclosure;

FIG. 5 is a schematic diagram of an example memory device including an array of memory cells and a peripheral circuit according to an implementation of the present disclosure;

FIG. 6 is a schematic diagram of a conventional read operation flow according to an implementation of the present disclosure;

FIG. 7A is a schematic diagram of a read error processing flow according to an implementation of the present disclosure;

FIG. 7B is another schematic diagram of a read error processing flow according to an implementation of the present disclosure;

FIG. 7C is yet another schematic diagram of a read error processing flow according to an implementation of the present disclosure;

FIG. 8 is a flow diagram of the method of operating a memory system according to an implementation of the present disclosure;

FIG. 9 is another flow diagram of the method of operating a memory system according to an implementation of the present disclosure.

In the above drawings (which are not necessarily drawn to scale), similar reference numerals may describe similar components in different views. Similar reference numerals with different letter suffixes may denote different examples of similar components. The drawings generally illustrate, by way of example and not limitation, various implementations discussed herein.

### DETAILED DESCRIPTION

The example implementations of this disclosure will be fully described below in conjunction with the accompanying drawings. Although example implementations of the present disclosure are shown in the accompanying drawings, it should be understood that the present disclosure may be implemented in various forms and should not be limited by some implementations set forth herein. Rather, these implementations are provided to enable a more thorough understanding of the disclosure and to fully convey the scope of the disclosure to those skilled in the art.

A lot of details are given in the following description to provide a more thorough understanding of the disclosure. However, it will be apparent to those skilled in the art that the present disclosure may be practiced without one or more of these details. Some technical features well known in the art are not described in other examples to avoid confusion with the present disclosure. That is, not all features of the actual implementations are described herein, and the well-known functions and structures are not described in detail.

The sizes of the layers, regions, elements and their relative sizes may be exaggerated in the drawings for the purpose of clarity. Throughout the description, the same reference numerals denote the same elements.

It should be understood that when an element or a layer is referred to as “on”, “adjacent to”, “connected to”, or “coupled to” other elements or layers, it may be directly on, adjacent to, connected to, or coupled to other elements or layers, or there may be interposed elements or layers. Conversely, when an element is referred to as “directly on,” “directly adjacent to,” “directly connected to,” or “directly coupled to” other elements or layers, there are no interposed elements or layers. The terms “first,” “second,” “third,” and the like are used for distinguishing similar objects and are not necessarily used for describing a particular order or sequence. The terms “first,” “second,” “third,” and the like may be used to describe various elements, parts, zones, layers, and/or portions, these elements, parts, zones, layers, and/or portions should not be limited by these terms. These terms are used only to distinguish one element, part, zone, layer, or portion from another element, part, zone, layer, or portion. Thus, without departing from the teachings of this disclosure, the first element, part, zone, layer, or portion discussed below may be represented as a second element, part, zone, layer, or portion. When a second element, part, zone, layer, or portion is discussed, it does not mean that a first element, part, zone, layer, or portion necessarily exists in the present disclosure. When a second element, part, zone, layer, or portion is discussed, it does not mean that a first element, part, zone, layer, or portion necessarily exists in the present disclosure.

The spatial relationship terms such as “under”, “below”, “the below”, “on”, “above”, “the above”, etc. may be used herein for ease of description, and thereby used to describe the relationship of one element or feature shown in the drawings with other elements or features. It should be understood that in addition to the orientations shown in the drawings, the spatial relationship terminology can be intended to include different orientations of the device in use and operation. For example, if the device in the accompanying drawings is turned over, then the element or feature described as “under” or “below” other elements can be oriented to be “on” or “above” the other elements or features. Thus, the example terms “under” and “below” may include both up and down orientations. The device may be oriented in other ways (rotated 90 degrees or in other orientations) and the spatial description terms used herein are interpreted accordingly.

The terms used herein are only for the purpose of describing some implementations and are not a limitation of the present disclosure. As used herein, the singular forms “a”, “an”, and “the/that” can also be intended to include the plural forms, unless the context clearly indicates otherwise. It should also be understood that the terms “comprising” and/or “including”, when used in this specification, can identify the presence of the features, integers, operations, operations, components and/or parts, but do not exclude the presence of one or more other features, integers, operations, operations, components, and/or parts and/or components and/or groups. As used herein, the term “and/or” may include any and all combinations of the relevant listed items.

In order to provide a more detailed understanding of the features and technical aspects of implementations of the present disclosure, implementations of the present disclosure are described in detail below together with the accompanying drawings, which are provided for illustrative purposes only and are not intended to limit the implementations of the present disclosure.

It should be understood that references to “an implementation” or “one implementation” throughout the specification mean that particular features, features or characteristics related to the implementations are included in at least one implementation of the present disclosure. Thus, the phrase “in an implementation” or “in one implementation” appearing throughout the specification do not necessarily refer to the same implementation. In addition, these particular features, structures or characteristics may be combined arbitrarily and suitably in one or more implementations. It should be understood that in various implementations of the present disclosure, the sequence numbers of the above processes do not mean the order of execution, which should be determined by their functions and inherent logic, and should not constitute any limitation on the implementations the present disclosure. The above serial number of implementations of present disclosure are for description only and do not represent the advantages and disadvantages of the implementation.

The method disclosed in several implementations of present disclosure may be arbitrarily combined to get new method implementations without conflict.

The memory device in implementations of the present disclosure includes, but not limited to, a three-dimensional (3D) NAND type memory. Taking the 3D NAND type memory as an example to illustrate this application for ease of understanding.

With the increasing requirements for memory devices, there is a lot of room for improvement in memory devices and their systems.

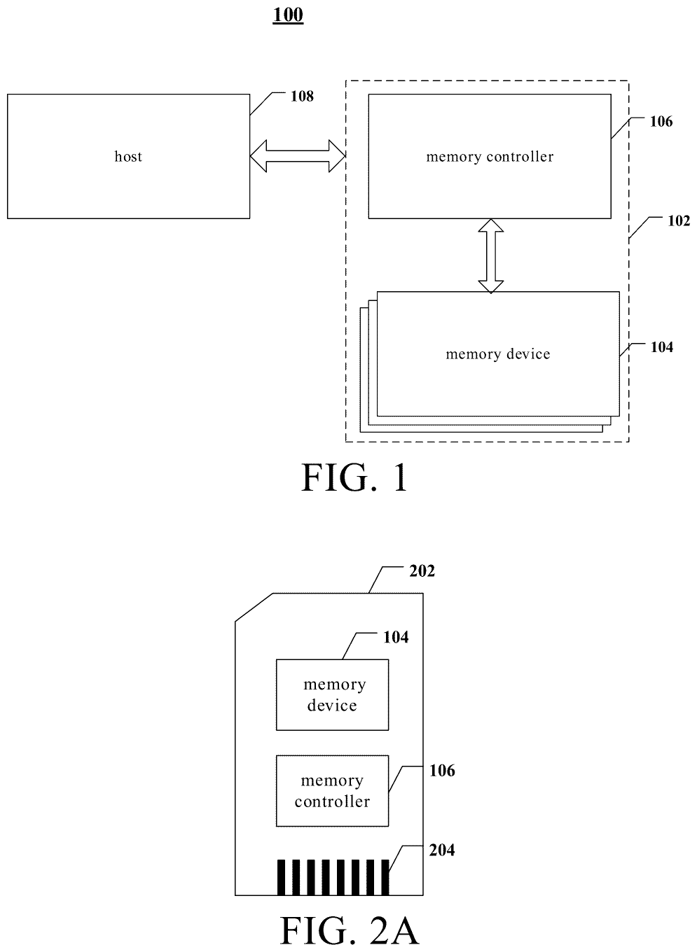

FIG. 1 illustrates a block diagram of an example system 100 having a memory device in accordance with some aspects of the present disclosure. System 100 may be a mobile phone, desktop computer, laptop computer, tablet computer, vehicle computer, game console, printer, positioning device, wearable electronic device, smart sensor, virtual reality (VR) device, augmented reality (AR) device, or any other electronic device having memory therein. System 100 as shown in FIG. 1 may include a host 108 and a memory system 102 having one or more memory devices 104 and a memory controller 106. The host 108 may be a processor of an electronic device (e.g. central processing unit (CPU)) or a system-on-chip (SoC) (e.g. application processor (AP)). The host 108 may be configured to send data to or receive data from memory device 104.

According to some implementations, the memory controller 106 is coupled to the memory device 104 and the host 108, and is configured to control the memory device 104. The memory controller 106 may manage data stored in the memory device 104, and communicate with the host 108. In some implementations, the memory controller 106 is designed to operate in low duty cycle, such as a secure digital (SD) card, compact flash (CF) card, universal serial bus (USB) flash drive or other media used in electronic devices such as personal calculators, digital cameras, mobile phones, and the like. In some implementations, the memory controller 106 is designed to operate in a high duty cycle SSD or embedded multimedia card (eMMC), which are used as a data store for devices such as smart phones, tablet computers, laptops, and the like, as well as enterprise memory arrays.

The memory controller 106 may be configured to control operations of the memory device 104, such as read, erase and program operations. The memory controller 106 may also be configured to manage various functions related to data stored or to be stored in the memory device 104 including, but not limited to, bad block management, garbage collection, logic to physical address translation, wear leveling, and the like. In some implementations, the memory controller 106 is further configured to process error correction codes (ECC) with respect to data read from or written to the memory device 104. The memory controller 106 may also perform any other function such as formatting the memory device 104. The memory controller 106 may communicate with an external device (e.g. host 108) according to a particular communication protocol. For example, the memory controller 106 may communicate with an external device through at least one of various interface protocols, such as USB protocol, MMC protocol, peripheral component interconnection (PCI) protocol, PCI express (PCI-E) protocol, advanced technology attachment (ATA) protocol, serial ATA protocol, parallel ATA protocol, small computer small computer interface (SCSI) protocol, enhanced small disk interface (ESDI) protocol, integrated drive electronics (IDE) protocol, Firewire protocol, and the like.

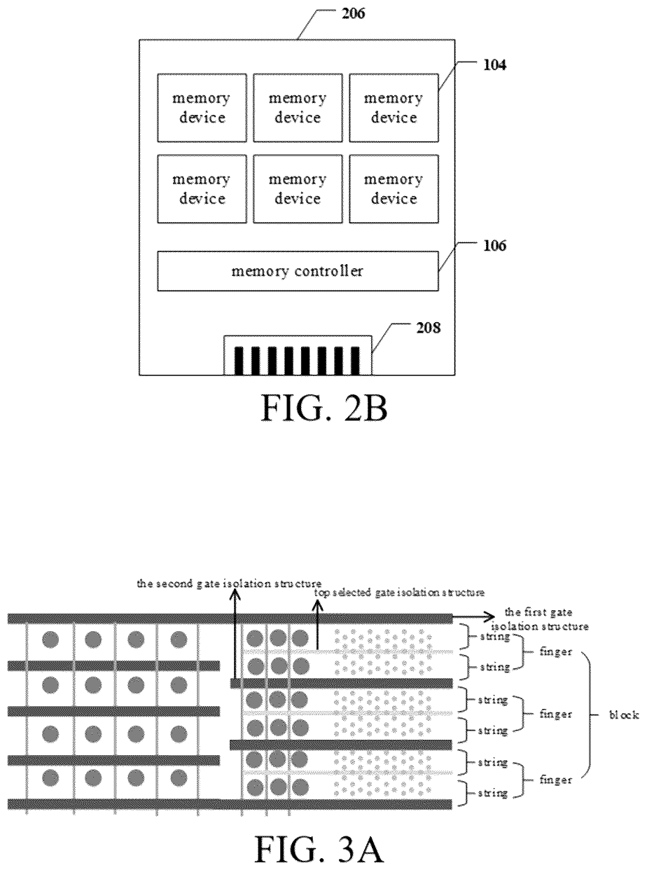

The memory controller 106 and one or more memory devices 104 may be integrated into various types of memory devices, for example, in the same package (e.g. universal flash storage (UFS) package or eMMC package). That is, the memory system 102 may be implemented and encapsulated in different types of terminal electronic products. In one example as shown in FIG. 2A, the memory controller 106 and a single memory device 104 may be integrated into the memory card 202. The memory card 202 may include a PC card (PCMCIA, Personal Computer Memory Card International Association), a CF card, a smart media (SM) card, a memory stick, a multimedia card (MMC, RS-MMC, MMCmicro), an SD card (SD, miniSD, microSD, SDHC), a UFS, and the like. The memory card 202 may also include a memory card connector 204 that couples the memory card 202 to a host (e.g., host 108 in FIG. 1). In another example as shown in FIG. 2B, the memory controller 106 and a plurality of memory devices 104 may be integrated into the SSD 206. The SSD 206 may also include an SSD connector 208 that couples the SSD 206 to a host (e.g., host 108 in FIG. 1). In some implementations, the storage capacity and/or operating speed of the SSD 206 is greater than those of the memory card 202.

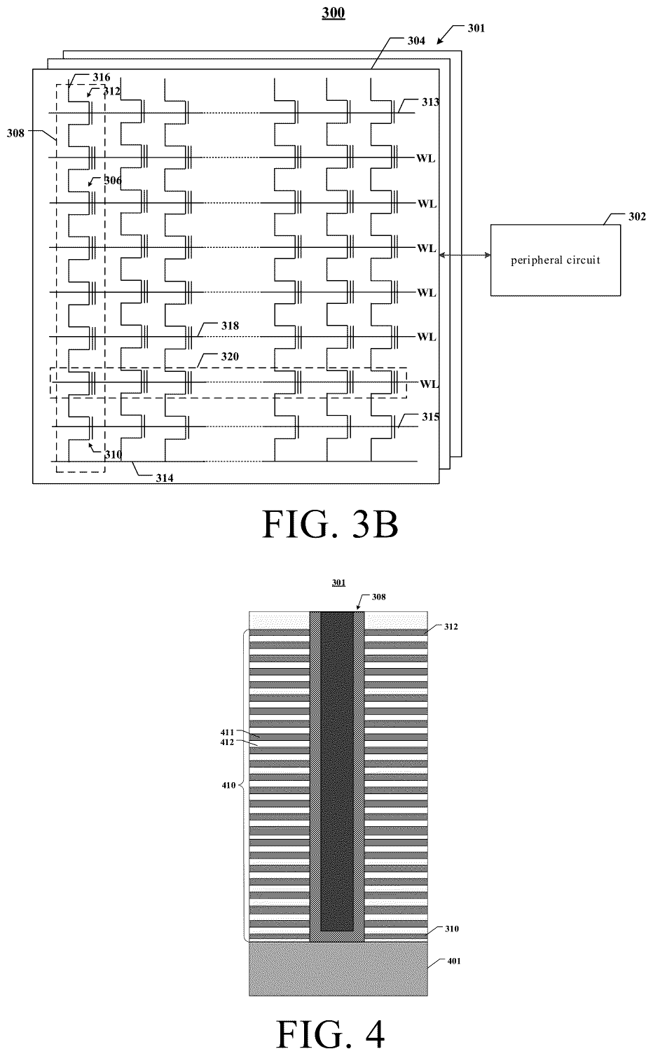

FIG. 3A exemplarily shows a structure schematic diagram of a memory cell array of 3D NAND type memory. As shown in FIG. 3A, the memory cell array of 3D NAND type memory is composed of a plurality of parallel staggered rows of memory cell rows parallel to the gate isolation structure. Every two rows of memory cell rows are spaced by the gate isolation structure and the top selected gate isolation structure. Each of the memory cell rows includes a plurality of memory cells. The gate isolation structure may include a first gate isolation structure that divides the memory cell array into a plurality of blocks and a second gate isolation structure that divides the blocks into a plurality of fingers. The top selected gate isolation structure provided in the middle of each finger may divide the finger into two parts so as to divide the finger into two strings. One block shown in FIG. 3A includes six strings. The number of strings in one block in practice is not limited thereto. A memory cell in a block coupled by a word line may be called a page.

It should be noted that the number of memory cell rows between the gate isolation structure and the top selected gate isolation structure shown in FIG. 3A is an example only and is not intended to limit the number of memory cell rows included in one finger of the 3D NAND type memory in the present disclosure. In practice, the number of memory cell rows contained in a finger may be adjusted according to the actual situation, such as 2, 4, 8, 16 and so on.

FIG. 3B shows a schematic circuit diagram of an example memory device 300 including a peripheral circuit according to some aspects of the present disclosure. The memory device 300 may be an example of memory device 104 in FIG. 1. The memory device 300 may include a memory cell array 301 and a peripheral circuit 302 coupled to the memory cell array 301. The memory cell array 301 may be illustrated as a 3D NAND type memory array, in which memory cells 306 are provided in the form of an array of 3D NAND type memory strings 308, each extending vertically above a substrate (not shown). In some implementations, each NAND memory string 308 includes multiple memory cells 306 coupled in series and stacked vertically. Each memory cell 306 may hold a continuous analog value, e.g., a voltage or charge, depends on the quantity of electrons trapped within an area of the memory cell 306. Each memory cell 306 may be a floating gate type memory cell including a floating gate transistor or a charge trapping type memory cell including a charge trapping transistor.

In some implementations, each memory cell 306 may be a single level cell (SLC) having two possible memory states and therefore capable of storing one bit of data. For example, a first memory state “0” may correspond to a first voltage range, and a second memory state “1” may correspond to a second voltage range. In some implementations, each memory cell 306 may be a multi-level cells (MLC) storing more than single bit of data in more than four memory states. For example, MLC may store two bits per cell and three bits per cell (also known as Triple-Level Cell (TLC)) or four bits per cell (also known as Quad-Level Cell (QLC)). Each MLC may be programmed to take a range of possible nominal stored values. In one example, if each MLC stores two bits of data, the MLC may be programmed to take one of three possible programming levels from the erase state by writing one of three possible nominal stored values to the cell. The fourth nominal stored value may be used for the erase state.

As shown in FIG. 3B. each memory string 308 may include a bottom selected gate (BSG) 310 at its source terminal and a top selected gate (TSG) 312 at its drain terminal. The BSG 310 and TSG 312 may be configured to activate the selected NAND memory string 308 during read and program operations. In some implementations, the sources of the NAND memory strings 308 in the same block 304 are coupled by the same source line (SL) 314 (e.g., a common SL). In other words, according to some implementation, all NAND memory strings 308 in the same block 304 may have an array common source (ACS). According to some implementations, the TSG 312 of each memory string 308 is coupled to a respective bit line (BL) 316, from which bit line 316 data may be read or written via an output bus (not shown). In some implementations, each memory string 308 is configured to be selected or deselected by applying a select voltage (e.g., higher than the threshold voltage of the transistor having the TSG 312) or a deselect voltage (e.g., 0V) to the respective TSG 312 via one or more TSG line 313 and/or by applying a select voltage (e.g., higher than the threshold voltage of the transistor having the BSG 310) or a deselect voltage (e.g., 0V) to the respective BSG 310 via one or more BSG 315.

As shown in FIG. 3B, the NAND memory strings 308 may be organized into a plurality of blocks 304, each of the plurality of blocks 304 may have a common source line 314 (e.g., coupled to ground). In some implementations, each block 304 is a basic unit of data for an erase operation, i.e., all memory cells 306 on the same block 304 are erased at the same time. In order to erase the memory cells 306 in the selected block, the source lines 314 coupled to the selected blocks 304a and unselected blocks 304b on the same plane as the selected memory blocks 304a may be biased with an erase voltage (Vers) (e.g. high positive voltage (e.g. 20V or higher)). It should be understood that in some examples, the erase operation may be performed at a half block level, at a quarter block level, or at any suitable fraction of a number of blocks or blocks. The memory cells 306 of adjacent memory strings 308 may be coupled by word lines 318, the word lines 318 selecting which row of memory cells 306 is affected by read and program operations. In some implementations, each word line 318 is coupled to a page 320 of memory cells 306. Page 320 is the basic data unit for program operation. A size of the page 320 in unit of bit may be related to a number of the NAND memory strings 308 coupled by a word line 318 in one block 304. Each word line 318 may include a plurality of control gates (gate electrodes) at each memory cell 306 in a respective page 320 and a gate line coupling the control gates. With reference to the above FIG. 3A, a page 320 contains a plurality of memory cells 306 spaced by a top selected gate isolation structure and a gate isolation structure. A plurality of memory cells between the top selected gate isolation structure and the gate isolation structure are arranged in a plurality of memory cell rows, each parallel to the gate isolation structure and the top selected gate isolation structure. The memory cells in strings sharing the same word lines form programmable (read/write) pages.

FIG. 4 shows a schematic cross-sectional view of example memory cell array 301 including a NAND memory string 308 according to some aspects of the present disclosure. As shown in FIG. 4, the NAND memory string 308 may include a stacked structure 410 including a plurality of gate layers 411 and a plurality of insulating layers 412 alternately stacked in turn and a memory string 308 perpendicularly penetrating the gate layers 411 and the insulating layers 412. The gate layer 411 and the insulating layer 412 may be alternately stacked. Two adjacent gate layers 411 are spaced by an insulating layer 412. The number of memory cells included in the memory cell array 301 is determined by the number of pairs of gate layers 411 and insulating layers 412 in the stacked structure 410.

The constituent material of the gate layer 411 may include a conductive material. The conductive material includes, but not limited to, tungsten (W), cobalt (Co), copper (Cu), aluminum (Al), polysilicon, doped silicon, silicide, or any combination thereof. In some implementations, each gate layer 411 may include a metal layer, for example, a tungsten layer. In some implementations, each gate layer 411 includes a doped polysilicon layer. Each gate layer 411 may include a control gate surrounding a memory cell. The gate layer 411 at the top of the stack structure 410 may extend laterally as a top selected gate line, and the gate layer 411 at the bottom of the stack structure 410 may extend laterally as a bottom selected gate line, and the gate layer 411 extending laterally between the top selected gate line and the bottom selected gate line may serve as a word line layer.

In some implementations, a stack structure 410 may be disposed on a substrate 401. The substrate 401 may include silicon (e.g. monocrystalline silicon), silicon germanium (SiGe), gallium arsenide (GaAs), germanium (Ge), silicon on insulator (SOI), germanium on insulator (GOI) or any other material.

In some implementations, the NAND memory string 308 includes a channel structure that extends vertically through the stack structure 410. In some implementations, the channel structure includes a channel hole filled with a semiconductor material(s) (e.g. as a semiconductor channel) and a dielectric material(s) (e.g. as a memory film). In some implementations, the semiconductor channel comprises silicon, such as polysilicon. In some implementations, the memory film is a composite dielectric layer including a tunneling layer, a memory layer (also referred to as a “charge trapping/storage layer”) and a barrier layer. The channel structure may have a cylindrical shape (e.g. a pillar shape). According to some implementations, the semiconductor channel, the tunneling layer, the memory layer and the barrier layer are arranged radially from the center of the cylinder toward the outer surface of the cylinder in this order. The tunneling layer may include silicon oxide, silicon oxynitride, or any combination thereof. The memory layer may include silicon nitride. silicon oxynitride or any combination thereof. The barrier layer may comprise a silicon oxide, silicon oxynitride, high dielectric constant (high k) dielectric or any combination thereof. In one example, the memory film may include a composite layer of silicon oxide/silicon oxynitride/silicon oxide (ONO).

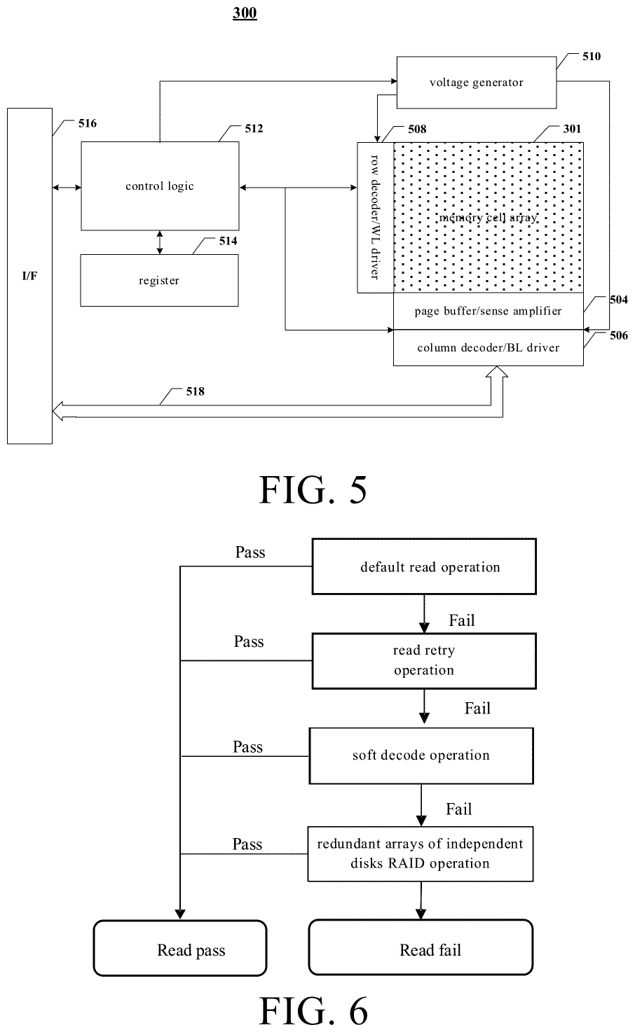

Referring back to FIG. 3B, the peripheral circuit 302 may be coupled to the memory cell array 301 through the bit line 316, the word line 318, the source line 314, the BSG line 315, and the TSG line 313. The peripheral circuit 302 may include any suitable analog, digital, and mixed-signal circuit for facilitating operation of the memory array 301 by applying and sensing voltage and/or current signals to and from each target memory cell 306 via the bit line 316, the word line 318, the source line 314, the BSG line 315, and the TSG line 313. The peripheral circuit 302 may include various types of peripheral circuit formed using metal-oxide-semiconductor (MOS) technology. For example, FIG. 5 shows some example peripheral circuits. The peripheral circuit 302 may include a page buffer/sense amplifier 504, a column decoder/bit line driver 506, a row decoder/word line driver 508, a voltage generator 510, control logic circuit 512, register 514, interface 516, and data bus 518. It should be understood that, in some examples, additional peripheral circuits not shown in FIG. 5 may also be included.

The page buffer/sense amplifier 504 may be configured to read data from the memory cell array 301 and program (write) data to the memory cell array 301 based on a control signal from the control logic circuit 512. In one example, the page buffer/sense amplifier 504 may store a page of program data (write data) to be programmed into one page 320 of the memory cell array 301. In another example, the page buffer/sense amplifier 504 may perform a program verify operation to ensure that data has been properly programmed into the memory cell 306 coupled to the selected word line 318. In yet another example, the page buffer/sense amplifier 504 may sense low power signals from the bit line 316 representing data bits stored in memory cells 306 and amplify small voltage swings to recognizable logic levels in a read operation. The column decoder/bit line driver 506 may be configured to be controlled by the control logic 512 and select one or more memory strings 308 by applying a bit line voltage generated from the voltage generator 510.

The row decoder/word line driver 508 may be configured to be controlled by the control logic 512 and to select/deselect a block 304 of the memory cell array 301 and to select/deselect a word line 318 of the block 304. The row decoder/word line driver 508 may also be configured to drive the word line 318 using the word line voltage generated from the voltage generator 510. In some implementations, the row decoder/word line drivers 508 may also select/deselect and drive the BSG line 315 and TSG line 313. As described in detail below, the row decoder/word line driver 508 is configured to perform a program operation on the memory cells 306 coupled to the selected word line(s) 318. The voltage generator 510 may be configured to be controlled by the control logic 512 and generate a word line voltage (e.g., a read voltage, a program voltage, a pass voltage, a channel voltage, a verify voltage, etc.), a bit line voltage, and a source line voltage to be supplied to the memory cell array 301.

In some implementations, the program operation may include a plurality of stages. As an example, the program operation may include a channel pre-charge stage, a channel boost stage, a program pulse stage and a recovery stage. In the channel pre-charge stage, the voltage generator may generate the voltage needed in the next stage, such as the voltage applied to each gate, the boost voltage. In the channel boost stage, a channel boost voltage may be applied to the selected word line. In the program pulse stage, the target voltage for each program may be applied to the selected word line. In the recovery stage, the voltages may be reduced to respective voltages, such as Vcc, Vdd, for unselected word line and the selected word line, by one or more operationped down operations. For example, the voltage may be reduced to an intermediate voltage and maintains for some period, and then reduced to the corresponding voltage.

The control logic 512 may be coupled to each of the peripheral circuits described above and configured to control the operation of each of the peripheral circuits. The register 514 may be coupled to the control logic 512 and include a status register, a command register and an address register for storing status information, a command operation code (OP code), and a command address for controlling the operation of each peripheral circuit. Interface 516 may be coupled to the control logic 512 and act as a control buffer to buffer and relay control commands received from a host (not shown) to the control logic 512 and to buffer and relay status information received from the control logic 512 to the host. The interface 516 may also be coupled to the column decoder/bit line drivers 506 via a data bus 518 and act as a data I/O interface and data buffer to buffer data and relay it to or from the memory cell array 301.

In some implementations of memory system, when system 100 operates, the host 108 sends commands to memory system 102 in response to a user's task requirements to retrieve data from or store data in memory system 102. When the host 108 processes task requirements from users, it needs the data interaction with memory system 102. The memory controller 106, memory device 104, various interfaces and other devices in memory system 102 are in an operating state, or the memory regions in the memory device 104 are in an operating state. The memory regions of the memory device 104 in this example may be one or more or all of the blocks shown in FIG. 3A, and it may also include one or more or all of the strings in a block. The memory device 104 may include a plurality of dies. The memory regions in the memory device 104 may include one or more or all of dies. A die may include a plurality of blocks. The die is a semiconductor structure including memory cell array and cut from a wafer according to a cutting path in the fabrication of a memory device 104. A plurality of dies form a chip by hybrid bonding or other integration ways. The operating state may include a state in which any one of a program operation, a read operation, or an erase operation is performed. The memory regions in the memory device 104 in an operating state may include a portion of the memory regions (a portion of the memory cell arrays) in an operating state or all of the memory regions (all of the memory cell arrays) in an operating state.

In some implementations, the memory controller 106 receives a command from the host 108 to control a memory region in the memory device 104 to perform a program operation, a read operation or an erase operation. The memory device 104 is in an operating state. In some implementations, the memory controller 106 may control the memory device 104 to perform operations such as garbage collection, wear leveling and the like when no command is received from the host 108.

In some implementations of memory system, when no operation is performed on a memory region in memory device 104 for a period of time, i.e., the memory region in memory device 104 has been idle for a period of time without being programmed, read or erased, if the idle memory region may be required to be read, a high read fail bit count (FBC) may occur in the first read operation, the number of read errors may be a great deal, but the subsequent read FBC may drop to a normal level. This phenomenon may be called temporary read errors (TRE). The appearance of TRE phenomenon may affect the quality of service of the memory system to a certain extent.

In some implementations, when the memory regions in the memory device 104 are idle for a period of time without any operation, the memory device 104 may be in a power-on state, but the corresponding operating voltages are not applied to the word lines or bit lines; or the memory device 104 may be in a power-down state (e.g. a shut-down state). At this time, TRE may occur when the memory device is restored to the operating state. The TRE phenomenon in the case where the non-operating state is restored, through powering on, to the operating state when powered down is more serious than that in the case where the non-operating state is restored to the operating state when powered on.

The reason for the occurrence of TRE in NAND memory may be explained according to the physical structure of the memory cell. In some implementations, as shown in FIG. 4, the NAND memory string 308 has semiconductor channels. The semiconductor channel may comprise polysilicon or other semiconductor materials. The difference in occupancy of the grain boundary traps (GBT) of semiconductor channels is one of the reasons for the large difference in FBC between the first read operation and the second read operation. Take the semiconductor channel of polysilicon as an example. When the memory cells in the NAND memory string 308 are programmed (written), the GBT of the polysilicon channel at the quasi-Fermi level will be occupied due to the high voltage of the word line. When the programming is finished, the electrons in the GBT of different energy levels will gradually migrate and leak current with the word line voltage gradually reduced to 0V from programming voltage; while the leaky GBT of the polysilicon channel will increase when the NAND memory string 308 changes from the operating state to the non-operating state without programming, reading and erasing, and thus lead to a lower GBT occupancy rate. When the NAND memory string 308 restores to the operating state, the first read operation may result in a higher read FBC due to a lower GBT occupancy. In other implementations, the charge trapping/storage layer of the NAND memory string 308 may also cause a decrease in GBT occupancy because no voltage is applied to the word line, which may also cause TRE phenomenon of the memory device 104. As an example, some memory regions in a memory device 104 store cold data which is not frequently programmed, read or erased. The memory region storing the cold data is in a non-accessed state for a long time. When the above memory region is restored to the operating state, a severe TRE phenomenon occurs and the FDC of the first read is higher.

In the second read operation after the first read operation, the leaky GBT in the polysilicon channel is refilled because of the applied read voltage or the pass voltage (Vpass) on the word line which may be greater than 5V at the time of the first read operation, thus the occupancy of the GBT is higher and close to the occupancy at the time of just programming, and the read FBC is less. It may be seen that when the GBT occupancy of the polysilicon channel is high, the read FBC will be smaller. The longer the processing time (duration) of the first read operation is, the longer the time for applying voltage to the word line is. The more the leaky GBT is filled, the less the read FBC is. Here, the non-operating state includes a power-on state and a power-down state. The TRE in the case where the non-operating state is restored to the operating state when powered down is more severe than the TRE in the case where the non-operating state is restored to the operating state when powered on. The TRE at low temperature is more serious than the TRE at high temperature. The thicker the polysilicon channel film is, the more serious the TRE is. The serious TRE needs more processing time of the first read to eliminate it.

In some example implementations of the disclosure, the TRE phenomenon may be eliminated or mitigated by optimizing the operating logic of the memory system 102 and the manufacturing process of the memory device 104, whereby the time during which the memory device 104 restores from a non-operating state to an operating state is reduced. For example, the TRE may be reduced by decreasing the thickness of the semiconductor channel film, and by reducing vacancy defect through improving film uniformity of semiconductor channel. For example, the first read operation may be defined as a pseudo read operation, and the following second read operation may be considered as the normal read operation. Here, the pseudo read operation may last for a period of time to eliminate the TRE phenomenon, for example 60 ms or longer. The memory controller 106 restores the memory system 102 to the normal read operation by monitoring that the FBC at the time of the pseudo read is less than the preset value of the normal read to determine that the memory device 104 is restored to the normal read level.

The processing time of the pseudo read operation may be determined by setting the pseudo read operation with different processing time for the memory device 104 and testing reading FBC. By establishing a test model and using machine learning and big data analysis, the duration for eliminating TRE under various working conditions may be determined. On this basis, a better reading effect may be achieved by increasing the processing time appropriately. For example, the processing time for the memory device 104 to eliminate the pseudo read of the TRE at 25° C. is 60 ms; the processing time for the memory device 104 to eliminate the pseudo read of TRE at 55° C. is 20 ms; the processing time for the memory device 104 to eliminate the pseudo read of TRE at 85° C. is 10 ms. The processing time is negatively related with temperature. The longest processing time of the pseudo read operation is determined based on the lowest operating temperature in the design standard of the memory device 104. The TRE phenomenon may also be eliminated when the memory device 104 is at other high temperatures. Temperature compensation may also be performed based on the corresponding relationship between the processing time and the temperature. The TRE phenomenon under different operating conditions may be eliminated by appropriately shortening the processing time based on the longest processing time at the lowest temperature.

The conventional read operation flow in this implementation shown with reference to FIG. 6 may include a default read operation already set in the firmware. A read retry operation is performed after the default read operation fails, a soft decode operation is performed after the read retry operation fails, a redundant arrays of independent disks (RAID) operation is performed after the soft decode operation fails, and the read operation stops after the RAID operation fails, and the read fails because the error cannot be corrected. The memory controller 106 sends the read failure signal to the host 108. The error correction operations such as read retry operation, soft decode operation and RAID operation may be performed by an error correction module (e.g., ECC module) in the memory controller 106. The control commands are sent by the memory controller 106 to the memory device 104 via interface 516. The memory device 104 feeds back the read information to the memory controller 106 via interface 516. It should be pointed out that any one of the read retry operation, soft decode operation and RAID operation may stop executing subsequent operations after successful reading.

In some example implementations, the memory controller 106 sends the execution command, logical-physical address and processing time of the pseudo read operation to the memory device 104. The memory device 104 does not send the read information from the memory cell to the memory controller 106 after performing the pseudo read operation, thereby saving the bandwidth of the bus or interface 516. Therefore, the pseudo read operation is generally independent of the read operation flow shown in FIG. 6. The additional firmware or operating program may be introduced by setting the pseudo read operation based on this to eliminate the TRE phenomenon. Thus the complexity of the firmware of program of memory controller 106 and memory device 104 may be increased, and the efficiency of read operation may be reduced.

According to some aspects of the implementations of this disclosure, a memory system 102 and the method of operating the memory system 102 are provided. The memory system 102 comprises: at least one memory device 104 and a memory controller 106 coupled to the at least one memory device 104; the memory controller 106 is configured to:
perform part or all of a read error processing flow for at least two times in response to a failure of a first read operation when performing a read operation on a memory region in the memory device 104.

In some implementations, before a read operation is performed on the memory region in memory device 104, no operation is performed on the memory region in memory device 104 for more than a preset length of time: wherein the operation may include a program operation, a read operation or an erase operation;
or
the first read operation when performing a read operation on the memory region in the memory device 104 is the first read operation when performing a read operation on the memory region in the memory device 104 after the memory system 102 is powered on.

In the implementations of the present disclosure, the first read operation may be the first read operation after the memory device 104 maintained in a power-on state has not been accessed, or has been idle for a period of time (a preset length of time), or the first read operation after the memory device 104 in a power-down state has been re-powered, which may also be referred to as the first read operation after the memory region in the memory device 104 is restored to an operating state. The method of testing the preset length of time may include: setting different lengths of time before performing two read operations. The correspondence with the lengths of time may be established by testing the increased amount of FBC of the second read operation compared with the first read operation. The longer the length of time is, the more serious the TRE phenomenon is and the more the FBC is. When the preset length of time exceeds a certain value, part or all of the read error processing flow may be required to be performed for at least two times, to eliminate the TRE phenomenon.

According to some aspects of the implementations of this disclosure, a memory system 102 and the method of operating the memory system 102 are provided. The memory system 102 comprises: at least one memory device 104 and a memory controller 106 coupled to the at least one memory device 104; the memory controller 106 is configured to: perform part or all of a read error processing flow for at least two times in response to a failure of a first read operation when performing a read operation on a memory region in the memory device 104.

The memory controller 106 interacts with the host 108 through an interface (e.g., PCIe interface, SATA interface). The memory controller 106 receives a read command from the host 108 through an interface such as PCIe, controls the control logic in the memory device 104 to read the memory cells corresponding to the physical address in the memory cell array according to the logic-physical address map, and sends the read information to the memory controller 106, which then sends the read information to the host 108. When the memory controller 106 controls the memory device 104 to perform the default read operation, the read operation may perform hard decoding at this time, and if a read error occurs, an error correction operation such as ECC error correction will be triggered.

When the host 108 needs relevant data, it sends a read instruction to the memory controller 106. In response to the data read instruction of the host 108, the memory controller 106 controls the memory device 104 to restore from the non-operating state to the operating state. At this time, the memory device 104 and the interface such as PCIe are powered on and in the rated working state. The memory controller 106 controls the memory device 104 to read the memory cell with the physical address corresponding to the logical address. The memory controller 106 may control the memory device 104 to perform operations such as garbage collection, wear leveling or the like without instructions from the host 108 based on the self-management requirement or performance optimization of the memory system 102. The memory controller 106 controls the memory device 104 to restore to an operating state.

The memory controller 106 controls the memory device 104 to first perform a first default read operation on the corresponding memory cell based on the conventional read operation flow shown in FIG. 6. The read voltage is the default read voltage in the relevant table of read voltage. The read operation may succeed, or the first default read failure may occur due to the TRE phenomenon. When the memory controller 106 determines that the first default read operation fails, the memory controller 106 controls the memory device 104 to perform part or all of a read error processing flow for two times. The read error processing flow in the implementations of the present disclosure may include the error correction operations such a read retry operation, a soft decode operation and a RAID operation shown in FIG. 6 and the execution sequence and logic are also shown in FIG. 6.

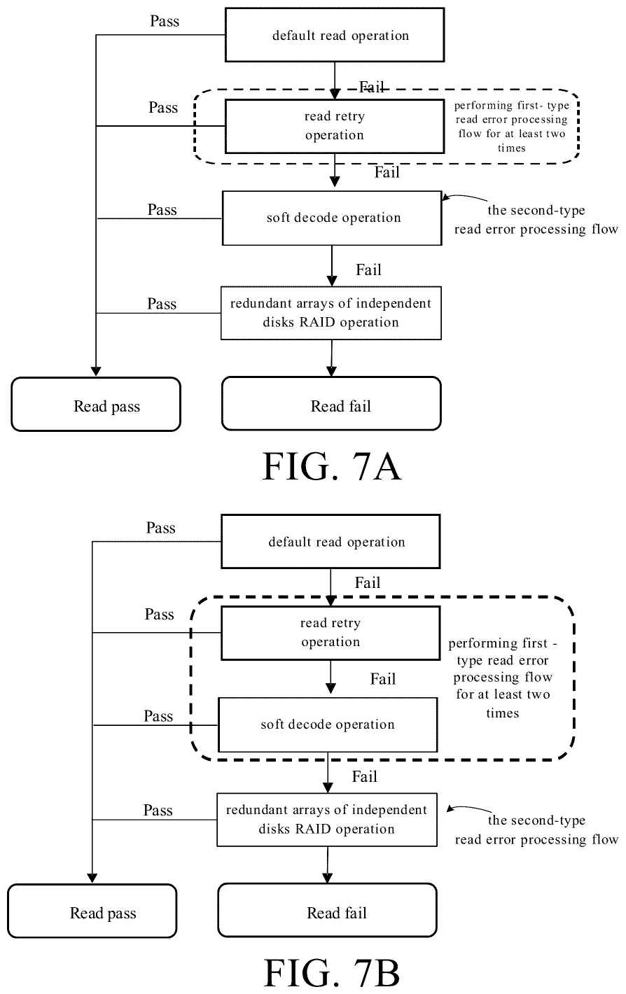

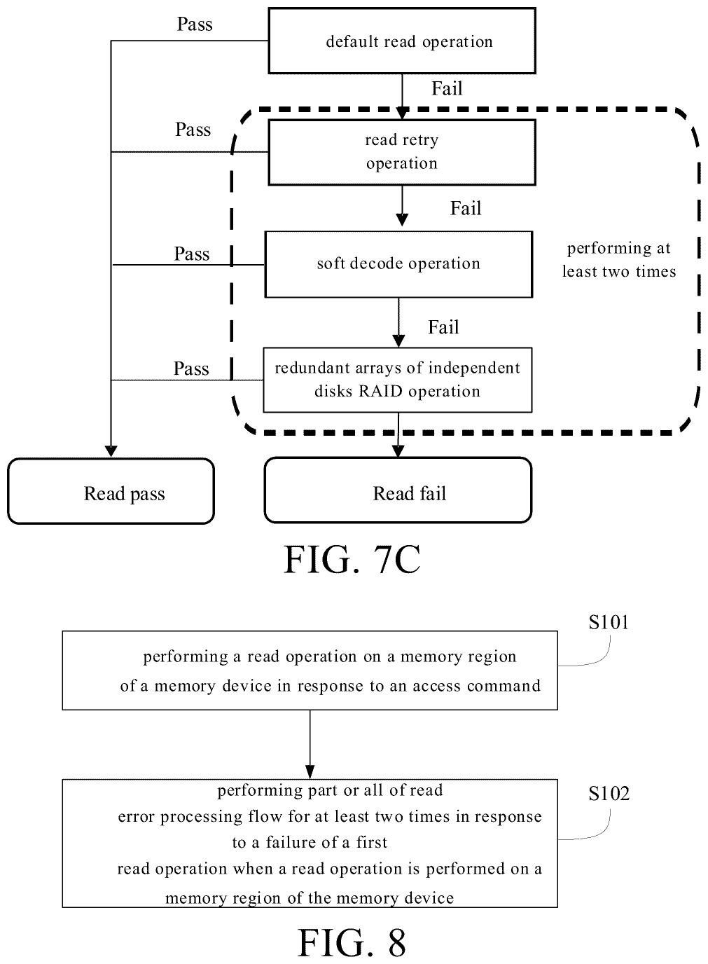

Referring to FIG. 7A, when the memory controller 106 determines that the first default read operation fails, two or more read retry operations are performed. The read retry operation may use hard decode operation. A preset duration may be set between two adjacent read retry operations.

In some implementations, the flow of determining the read retry voltage may include: the memory controller 106 (e.g. ECC module in memory controller 106) acquiring a corresponding voltage offset value, which may be positive or negative, by querying a corresponding read retry table. The voltage offset value is added with a default read voltage to get a read retry voltage. The memory controller 106 controls the memory device 104 to read retry a memory cell of a corresponding physical address using the read retry voltage. It should be noted that the memory controller 106 may query the read retry table in a polling mode. The read retry table may include multiple sub-tables, such as m sub-tables, wherein m is a natural number greater than 1. Each sub-table may include a voltage offset value for a corresponding memory state of a corresponding memory cell. One voltage offset value is obtained in one query. The values queried from the first sub-table to the m-th sub-table are added together to a read retry voltage, with which the memory device to read. Therefore, for a single read retry operation, there may be a sub-read operation with a maximum of m times, which is not limited in this implementation. Only the total processing time is needed to eliminate the TRE phenomenon and restore the conventional read operation flow.

In some implementations, the processing time per read retry operation may be an average processing time obtained by multiple test before delivery. The total process duration (without the preset duration for spacing) of multiple read retry operations is greater than or equal to the processing time of the pseudo read in some implementations, i.e., greater than or equal to the minimum duration for eliminating TRE phenomenon at the current temperature. The total processing time may be a first duration for eliminating the TRE phenomenon determined according to the temperature at which the memory device 104 is, that is, a duration for the memory device 104 to restore an operating state in which the conventional read operation flow shown in FIG. 6 may be performed.

For example, at 25° C., the total processing time of multiple read retry operations is greater than or equal to 60 ms. The preset duration for spacing may include: 0-100 ms, for example 10 ms. The preset duration may be determined according to the GBT leakage rate of the semiconductor channel when the memory device 104 is in the operating state. With this preset duration, the GBT of the semiconductor channel basically has no leakage or less leakage. The GBT occupancy is basically not reduced or the reduced amplitude is small so as not to cause a large increase in FBC. At this time, the default read voltage may still distinguish different memory states of the memory cells. Within the preset duration for spacing, the memory controller 106 may determine whether the read retry operation is passed, or determine that the TRE phenomenon is eliminated by counting the FDC meets the preset conditions of the operating state. Therefore, it is determined whether to continue the subsequent read retry operation. In this way, operating time is saved and the reading rate is increased. When multiple read retry operations fail, the TRE phenomenon has been eliminated at this time, and the read operation still fails, it may be determined that the failure of read operation is not caused by the TRE phenomenon, and a soft decoding operation may be performed at this time.

In some implementations, continue to refer to FIG. 7A, the read error processing flow as shown in FIG. 7A may be exited when read operation is successful after one read retry operation, or the preset number of times of read retry operation is not reached, that is, the total processing time of multiple read retry operations has not reached the preset duration (the first duration). The next read may be in the normal read operation flow shown in FIG. 6. In some other implementations, multiple read retry operations must be performed to ensure that the TRE phenomenon is eliminated no matter whether the read retry operation is passed or not. If the last read retry operation fails, one or more read retry operations may be performed continuously or soft decode operation may be performed.

In some implementations, as shown in FIG. 7B, taking the read retry operation and soft decode operation as an overall processing flow, the processing flow of performing read retry operation and soft decode operation in sequence may be defined as the first-type read error processing flow, and the parity check operation of RAID is defined as the second-type read error processing flow. The average processing time of the first-type read error processing flow is less than that of the second-type read error processing flow. When the memory controller 106 determines that the first default read operation fails, it performs first-type read error processing flow for two times, and a duration for spacing may be set between adjacent times of the first-type read error processing flow. In a first-type read error processing flow, there may also be a duration between a read retry operation and a soft decode operation. When the read operation still fails through multiple first-type read error processing flow, the TRE phenomenon has been eliminated at this time, and the read operation still fails, it may be determined that the failure of read operation is not caused by the TRE phenomenon. At this time, a RAID operation may be performed.

In some implementations, referring to FIG. 7C, the read retry operation, the soft decode operation and the RAID operation will be executed sequentially, and circularly executed for two or more times, that is, all of the read error processing flow is performed for two or more times. In some implementations, the soft decode operation may be understood as re-decoding of data by a decoding part (such as a soft decoder) in the memory controller 106, and performing a read operation again according to the re-decoded data. The RAID operation may be understood as mirroring data through second encoding, and reconstructing stored data and its parity data, wherein, the stored data is usually re-encoded with redundant array in the data buffer of the memory controller 106.

In some implementations, the memory controller 106 may acquire the current temperature of the memory device 104 or the memory system 102 to determine the total processing time of the read error processing flow. The lower the temperature, the more serious the TRE phenomenon of the memory device 104, and the longer the total processing time of the read error processing flow is required. The processing flow shown in FIGS. 7A to 7C may be flexibly selected. The conventional read operation flow shown in FIG. 6 has been written into executing firmware or program when the memory system 102 leaves the factory. The processing time of each operation is fixed. For the same total processing time, the times of loop for the read retry operation shown in FIG. 7A is the most, the times of loop for performing the first-type read error processing flow shown in FIG. 7B is the second, and the times of loop of performing all of the read error processing flows shown in FIG. 7C is the least. Conversely, in the case of different total processing time, for the minimum total processing time, the processing flow shown in FIG. 7A may be selected, for the medial total processing time, the processing flow shown in FIG. 7B may be selected, and for the maximum total processing time, the processing flow shown in FIG. 7C may be selected.

The implementations of present disclosure are based on the conventional read operation flow including error correction operation shown in FIG. 6. After the first default read operation fails, the pseudo read operation is substituted with part or all of error correction operation flow (such as a read retry operation, a soft decode operation and a RAID operation) being performed for a plurality of times. The total duration of above error correction operations is greater than or equal to the duration of the pseudo read operation (i.e., the duration to eliminate TRE) in the related technical scheme, thus the TRE phenomenon, which occurs at the time of the memory region in the memory device 104 being restored to the operating state, is eliminated. The implementations of the present disclosure eliminate the TRE phenomenon using default read operation firmware or program installed in the original memory system 102 without adding additional firmware or operations to the original read operation flow firmware or program operations, which is beneficial to reduce the number of the firmware or programs to facilitate the reduction of the development cost and the processing load of the memory controller 106.

In some implementations, referring to FIG. 7B, the read error processing flow of the memory device 104 comprises a first-type read error processing flow and a second-type read error processing flow which are performed in sequence: the average processing time of the first-type read error processing flow is less than that of the second-type read error processing flow.

In some implementations, referring to FIG. 7B, the first-type read error processing flow comprises: a read retry operation and a soft decode operation; the second-type read error processing flow comprises: independent disk redundant array RAID operation. The first-type read error processing flow is identified by dashed lines in the schematic diagram of the operation flow in FIG. 7B. The memory controller 106 sequentially performs the read retry operation and the soft decode operation, in response to the failure of the first default read operation when the memory region in the memory device 104 is restored to the operating state.

In some implementations, referring to FIG. 7B, the memory controller 106 may be configured to:
perform the soft decode operation on the read data in response to a failure of the read retry operation during each execution of the first-type read error processing flow. In other implementations, in response to the success of the read retry operation, the soft decode operation is still performed until first-type read error processing flow is performed for a preset number of times, to ensure a sufficient total processing time to eliminate the TRE phenomenon.

In some implementations, referring to FIG. 7B, the first-type read error processing flow is performed for at least two times in response to a failure of the first read operation after a memory region in the memory device 104 is restored to an operating state.

In some implementations, referring to FIG. 7B, the memory controller 106 is configured to:
perform the second-type read error processing flow in response to the failure of the read operation after the first-type read error processing flow have been performed for at least two times.

In this implementation, when the first-type read error processing flow are performed for multiple times but the read operation still fails, at this time, the TRE phenomenon has been eliminated. It may be determined that fail of the read operation is not caused by the TRE phenomenon, and the RAID operation may be performed at this time. Alternatively, when the first-type reading error processing flow is still not passed, it is considered that the total processing time of the first-type reading error processing flow being performed for multiple times is not enough to eliminate the TRE phenomenon, and the processing time still needs to be increased. Then the RAID operation which requires longer processing time is performed to eliminate the TRE phenomenon. No matter in which processing flow the read operation passes, the error processing flow shown in FIG. 7B may be existed. The next read operation is in the normal read operation flow shown in FIG. 6. Alternatively, the first-type read error processing flow may be performed multiple times regardless of whether the read retry operation passes or not, to ensure that the TRE phenomenon is eliminated.

In some implementations, referring to FIG. 7B, the memory controller 106 is configured to:
send a message for read failure in response to the failure of the read operation after the second-type read error processing flow is performed.

There is enough processing time to eliminate the TRE phenomenon after performing the read retry operation, the soft decode operation and the RAID operation which requires longer processing time. If the read operation still fails at this time, it is considered that the ECC error correction mechanism of the memory controller 106 may not be able to correct the error. In this case, the data may be lost or damaged. The memory controller 106 sends a message for read fail to the host 108. The second read operation may be performed according to the conventional read flow shown in FIG. 6.

In some implementations, the memory controller 106 is configured to:
space two adjacent times of the first-type read error processing flow with a preset duration.

The first-type read error processing includes a single read retry operation or a loop of read retry operation and soft decode operation. A preset duration may be spaced between two times of the first-type read error processing flow, or a preset duration may be spaced between two times of read retry operation and soft decode operation. The range of the preset duration for spacing may include: 0-100 ms, for example 10 ms. The duration for spacing is so small as not to cause a new TRE phenomenon. Within the preset duration for spacing, the memory controller 106 may determine whether the read operation passes or count the FDC to determine whether the count meets a conventional preset condition to determine that the TRE phenomenon is eliminated, and from the result of the decisions, it is determined whether to proceed the subsequent operations, so as to save the operating time and improve the reading rate.

In some implementations, the first-type read error processing shown in FIG. 7A, which is different from that shown in FIG. 7B, includes one operation, the first-type read error processing flow comprises: a read retry operation;
the second-type read error processing flow comprises: a soft decode operation.

The read retry operation fails after being performed for multiple times, the soft decode operation is performed. After the soft decode operation fails, the independent disk redundant array RAID operation is performed. After the independent disk redundant array RAID operation fails, the memory controller 106 sends a message for read failure to the host 108.

In some implementations, referring to FIG. 7C, the first-type read error processing may include a read retry operation.

In some implementations, the memory controller 106 is configured to:
acquire a first duration which is longer than a duration in which the memory region in the memory device 104 is restored to an operating state;
determine a number of executions of the first-type read error processing flow based on the first duration.

In some implementations, the memory controller 106 is configured to:
determine the first duration according to the temperature at which the memory device 104 is; the first duration is negatively correlated with the temperature at which the memory device 104 is.

In some implementations, the memory controller 106 is configured to:
perform the first-type read error processing flow for multiple times until a preset number of times is reached, in response to a failure of the first read operation after the memory region in the memory device 104 is restored to the operating state.

The first duration is the total processing duration in which the first-type read error processing flow is performed for a plurality of times. The first duration does not include the preset durations between operations. After the first-type read error processing flow is performed for a plurality of times, the first-type read error flow may be a single read retry operation in FIG. 7A, or the read retry operation and the soft decode operation sequentially performed as shown in FIG. 7B. The average processing time of the single read retry operation and the soft decode operation of the same memory system 102 may be determined according to the firmware. The first duration may be determined according to the test data for the memory device 104 which corresponds to different temperatures eliminating the TRE, and then the number of executions for the first duration may be determined. During the execution of the first-type read error processing flow, the read operation is successful while the preset duration is not reached, the first-type read error processing flow may be exited, and the next read operation is performed according to the conventional read operation flow shown in FIG. 6. Alternatively, the first-type read error processing flow is performed multiple times until the preset number of times is reached regardless of whether the read operation is successful or not, thus to ensure that the TRE phenomenon is eliminated. The next read operation is performed according to the conventional read operation flow shown in FIG. 6. After the first-type read error processing flow is performed for preset number of times, if the read operation still fails, the RAID operation is performed. If the read operation still fails, the memory controller 106 sends a message for read failure to the host 108.

In some implementations, the memory system 102 comprises a universal flash memory UFS device or an embedded multimedia card eMMC device.

According to some aspects of the implementations of present disclosure, FIG. 8 provides a method of operating a memory system 102, the method of operating comprising:
performing a read operation on a memory region in a memory device 104 in response to an access command;
performing part or all of a read error processing flow for at least two times in response to a failure of a first read operation when performing a read operation on a memory region in the memory device 104.

In some implementations, no operation is performed on the memory region in memory device 104 for more than a preset length of time before performing a read operation on the memory region in memory device 104; wherein the operation may include a program operation, a read operation or an erase operation;
or
the first read operation when performing a read operation on the memory region in the memory device 104 is the first read operation when performing a read operation on the memory region in the memory device 104 after the memory system 102 is powered on.

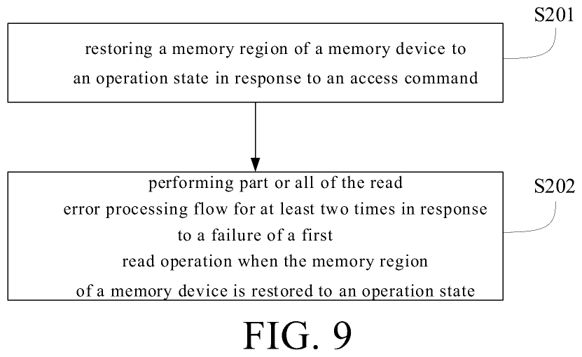

According to some aspects of the implementations of present disclosure, FIG. 9 provides a schematic diagram of a method of operating a memory system 102, the method of operating comprising:
restoring a memory region in the memory device 104 to an operating state in response to an access command;
performing part or all of a read error processing flow for at least two times in response to a failure of a first read operation after the memory region in the memory device 104 is restored to an operating state.

In implementations of the present disclosure, the access commands may be sent by the host 108 to the memory controller 106 via an interface, such as PCIe. The memory controller 106. restores the memory region in the memory device 104 to an operating state, in response to the access command. The memory controller 106 controls the memory device 104 to perform part or all of a read error processing flow for the at least two times in response to the failure of the first read operation after the memory region in the memory device 104 is restored to the operating state. Alternatively, the memory controller 106 may control the memory region in the memory device 104 to restore to the operating state to perform garbage collection, wear leveling or the like without command from the host 108 based on the requirements for the self-management of the memory system 102 or the command of performance optimization.

In some implementations, the read error processing flow of the memory device 104 includes a first-type read error processing flow and a second-type read error processing flow which are performed in sequence; the average processing time of the first-type read error processing flow is less than that of the second-type read error processing flow.

In some implementations, performing part or all of a read error processing flow at least two times further comprising:
performing the first-type read error processing flow for at least two times.

In some implementations, the method of operating further comprises:
spacing two adjacent times of the first-type read error processing with a preset duration.

In some implementations, the method of operating further comprises:
performing the second-type read error processing flow in response to failure of the read operation after the first-type read error processing flow is performed for at least two times.

In some implementations, the first-type read error processing flow comprises: a read retry operation and a soft decode operation;
the second-type read error processing flow comprises: independent disk redundant array RAID operation.

In some implementations, the method of operating further comprises:
performing the soft decode operation on the read data in response to a failure of the read retry operation during each execution of the first-type read error processing flow.

In some implementations, the method of operating further comprises:
sending a message for read failure in response to the failure of the read operation after the second-type read error processing flow is performed.

In some implementations, the first-type read error processing flow comprises: a read retry operation;
the second-type read error processing flow comprises: soft decode operation.

In some implementations, the method of operating further comprises:
acquiring a first duration which is longer than a duration in which the memory region in the memory device 104 is restored to an operating state;
determining a number of executions of the first-type read error processing flow based on the first duration.

In some implementations, the method of operating further comprises:
determining the first duration according to the temperature at which the memory device 104 is; the first duration is negatively correlated with the temperature at which the memory device 104 is.

In some implementations, the method of operating further comprises:
performing the first-type read error processing flow for multiple times until a preset number of times is reached, in response to a failure of the first read operation after the memory region in the memory device 104 is restored to the operating state.

According to some aspects of implementations of present disclosure, a readable storage medium is provided, on which a computer program is stored, when executed, the computer program performs the operation method of above implementations. The readable storage medium may include a NAND memory. The memory cells of the NAND memory may include a floating gate type memory cell of a floating gate transistor or a charge trapping type memory cell including a charge trapping transistor.

According to one aspect of implementations of the present disclosure, a memory system is provided, comprising:
at least one memory device and a memory controller coupled to the at least one memory device;
the memory controller is configured to:
perform part or all of a read error processing flow for at least two times in response to a failure of a first read operation when performing a read operation on a memory region in the memory device.

In some implementations, the read error processing flow of the memory device comprises performing a first-type read error processing flow and a second-type read error processing flow in sequence, the average processing time of the first-type read error processing flow is less than that of the second-type read error processing flow.

In some implementations, performing the first-type read error processing flow for at least two times in response to failure of the first read operation after the memory region in the memory device is restored to an operating state.

In some implementations, the memory controller is configured to:
space two adjacent times of the first-type read error processing flow with a preset duration.

In some implementations, the memory controller is configured to:
perform the second-type read error processing flow in response to a failure of the read operation after the first-type read error processing flow is performed for at least two times.

In some implementations, the first-type read error processing flow comprises: a read retry operation and a soft decode operation;
the second-type read error processing flow comprises: independent disk redundant array RAID operation.

In some implementations, the memory controller is configured to:
perform the soft decode operation on the read data in response to a failure of the read retry operation during each execution of the first-type read error processing flow.

In some implementations, the memory controller is configured to:
send a message for read failure in response to the failure of the read operation after the second-type read error processing flow is performed.

In some implementations, the first-type read error processing flow comprises: a read retry operation;
the second-type read error processing flow comprises: soft decode operation.

In some implementations, the memory controller is configured to:
acquire a first duration which is longer than a duration in which the memory region in the memory device is restored to an operating state;
determine a number of executions of the first-type read error processing flow based on the first duration.

In some implementations, the memory controller is configured to:
determine the first duration according to the temperature at which the memory device is; the first duration is negatively correlated with the temperature at which the memory device is.

In some implementations, the memory controller is configured to:
perform the first-type read error processing flow for multiple times until a preset number of times is reached, in response to a failure of a first read operation after the memory region in the memory device is restored to the operating state.

In some implementations, no operation is performed on the memory region in the memory device for more than a preset length of time before the read operation is performed on the memory region in the memory device; or
the first read operation when performing a read operation on the memory region in the memory device is the first read operation when performing a read operation on the memory region in the memory device after the memory system is powered on.

In some implementations, the memory system comprises a universal flash memory UFS device or an embedded multimedia card eMMC device.

According to one aspect of the implementations of this disclosure, a method of operating a memory system is provided, comprising:
performing a read operation on a memory region in a memory device in response to an access command;
performing part or all of a read error processing flow for at least two times, in response to a failure of a first read operation when performing a read operation on a memory region in the memory device.

In some implementations, the read error processing flow of the memory device comprises a first-type read error processing flow and a second-type read error processing flow which are performed in sequence; the average processing time of the first-type read error processing flow is less than that of the second-type read error processing flow.

In some implementations, performing part or all of a read error processing flow for at least two times further comprising:
the first-type read error processing flow is performed for at least two times in response to the failure of the first read operation after the memory region in the memory device is restored to an operating state.

In some implementations, the method further comprises:
spacing two adjacent times of the first-type read error processing flow with a preset duration.

In some implementations, the method further comprises:
performing the second-type read error processing flow in response to failure of the read operation after the first-type read error processing flow is performed for at least two times.

In some implementations, the first-type read error processing flow comprises: a read retry operation and a soft decode operation:
the second-type read error processing flow comprises: independent disk redundant array RAID operation.

In some implementations, the method further comprises:
performing the soft decode operation on the read data in response to a failure of the read retry operation during each execution of the first-type read error processing flow.

In some implementations, the method further comprises:
sending a message for read failure in response to the failure of the read operation after the second-type read error processing flow is performed.

In some implementations, the first-type read error processing flow comprises: a read retry operation;
the second-type read error processing flow comprises: soft decode operation.

In some implementations, the method further comprises:
acquiring a first duration which is longer than a duration in which the memory region in the memory device is restored to an operating state;
determining a number of executions of the first-type read error processing flow based on the first duration.

In some implementations, the method further comprises:
determining the first duration according to the temperature at which the memory device is; the first duration is negatively correlated with the temperature at which the memory device is.

In some implementations, the method further comprises:
performing the first-type read error processing flow for multiple times until a preset number of times is reached, in response to a failure of the first read operation after the memory region in the memory device is restored to the operating state.

In some implementations, no operation is performed on the memory region in the memory device for more than a preset length of time before the read operation is performed on the memory region in the memory device; or
the first read operation when performing a read operation on the memory region in the memory device is the first read operation when performing a read operation on the memory region in the memory device after the memory system is powered on.

Another aspect of the implementations of this disclosure provides a readable storage medium having a computer program stored thereon which, when executed, performs the above method of operating.

The implementations of this disclosure provide a memory system, comprising at least one memory device and a memory controller coupled to at least one memory device; the memory controller is configured to: perform part or all of a read error processing flow for at least two times in response to a failure of a first read operation after the memory region in the memory device is restored to the operating state. The situation in which the error rate of the first read is high upon the memory system being restored to the operating state is eliminated with the default read operation firmware or program provided by the original memory system without adding the original read operation flow firmware or program operations, which improves the read efficiency of the memory system while facilitating the reduction of the firmware or program to decrease the cost of development and reduce the processing load of the memory controller.

The foregoing are only implementations of the present disclosure, but the scope of protection of the present disclosure is not limited thereto. Any variation or permutation readily contemplated by those skilled in the art within the scope of the present disclosure should be covered within the scope of protection of the present disclosure. Therefore, the scope of protection of this disclosure shall be subject to the scope of protection of the claims.

What is claimed is:

1. A memory system, comprising:
a memory device; and
a memory controller coupled to the memory device, the memory controller is configured to:
perform part or all of a read error processing flow for at least two times, in response to a failure of a first read operation when performing a read operation on a memory region in the memory device.

2. The memory system of claim 1, wherein the read error processing flow of the memory device comprises a first-type read error processing flow and a second-type read error processing flow which are performed in sequence; an average processing time of the first-type read error processing flow is less than that of the second-type read error processing flow.

3. The memory system of claim 2, wherein the first-type read error processing flow is performed for at least two times, in response to the failure of the first read operation after the memory region in the memory device is restored to an operating state.

4. The memory system of claim 3, wherein the memory controller is configured to:
space two adjacent times of the first-type read error processing flow with a preset duration.

5. The memory system of claim 3, wherein the memory controller is configured to:
perform the second-type read error processing flow, in response to the failure of the read operation after the first-type read error processing flow is performed for at least two times.

6. The memory system of claim 5, wherein,
the first-type read error processing flow comprises: a read retry operation and a soft decode operation; and
the second-type read error processing flow comprises: an independent disk redundant array RAID operation.

7. The memory system of claim 5, wherein,
the first-type read error processing flow comprises: a read retry operation; and
the second-type read error processing flow comprises: a soft decode operation.

8. The memory system of claim 3, wherein the memory controller is configured to:
acquire a first duration which is longer than a duration in which the memory region in the memory device is restored to the operating state; and
determine a number of executions of the first-type read error processing flow based on the first duration.

9. The memory system of claim 8, wherein the memory controller is configured to:
determine the first duration according to a temperature at which the memory device is; the first duration is negatively correlated with the temperature at which the memory device is.

10. The memory system of claim 3, wherein the memory controller is configured to:
perform the first-type read error processing flow for multiple times until a preset number of times is reached, in response to the failure of the first read operation after the memory region in the memory device is restored to the operating state.

11. A method of operating a memory system, comprising:
performing a read operation on a memory region in a memory device, in response to an access command; and
performing part or all of a read error processing flow for at least two times, in response to a failure of a first read operation when performing a read operation on the memory region in the memory device.

12. The method of claim 11, wherein the read error processing flow of the memory device comprises a first-type read error processing flow and a second-type read error processing flow which are performed in sequence; an average processing time of the first-type read error processing flow is less than that of the second-type read error processing flow.

13. The method of claim 12, wherein performing part or all of a read error processing flow for at least two times, comprises:
performing the first-type read error processing flow for at least two times, in response to the failure of the first read operation after the memory region in the memory device is restored to an operating state.

14. The method of claim 13, further comprising:
spacing two adjacent times of the first-type read error processing flow with a preset duration.

15. The method of claim 13, further comprising:
performing the second-type read error processing flow, in response to the failure of the read operation after the first-type read error processing flow is performed for at least two times.

16. The method of claim 15, wherein,
the first-type read error processing flow comprises: a read retry operation and a soft decode operation; and
the second-type read error processing flow comprises: an independent disk redundant array RAID operation.

17. The method of claim 15, wherein,
the first-type read error processing flow comprises: a read retry operation; and
the second-type read error processing flow comprises: a soft decode operation.

18. The method of claim 13, further comprising:
acquiring a first duration which is longer than a duration in which the memory region in the memory device is restored to the operating state; and
determining a number of executions of the first-type read error processing flow based on the first duration.

19. The method of claim 18, further comprising:
determining the first duration according to a temperature at which the memory device is; the first duration is negatively correlated with the temperature at which the memory device is.

20. A readable storage medium having a computer program stored thereon which, when executed, performs a method of operating a memory system, comprising:
performing a read operation on a memory region in a memory device, in response to an access command; and
performing part or all of a read error processing flow for at least two times, in response to a failure of a first read operation when performing a read operation on the memory region in the memory device.
